(19) United States
(12) Patent Application Publication
(10) Pub. No.: US 2011/0042365 A1
(43) Pub. Date: Feb. 24, 2011

(54) WELDING METHOD AND WELDING JOINT STRUCTURE

(76) Inventors: Kazuo HIRAOKA, Ibaraki (JP); Terumi Nakamura, Ibaraki (JP)

Correspondence Address: WENDEROTH, LIND & PONACK, L.L.P., 1030 15th Street, N.W.,, Suite 400 East, Washington, DC, 20005-1503, US

(21) Appl. No.: 12/905,646

(22) Filed: Oct. 15, 2010

Related U.S. Application Data
(63) Continuation of application No. 12/073,630, filed on Mar. 7, 2008.
Application No. 12/073,630 is a continuation of application No. 11/889,005, filed on Aug. 8, 2007, now abandoned.
Application No. 11/889,005 is a continuation of application No. 11/526,030, filed on Sep. 25, 2006, now abandoned.
Application No. 11/526,030 is a continuation of application No. 11/019,972, filed on Dec. 23, 2004, now abandoned.
Application No. 11/019,972 is a continuation of application No. 10/661,584, filed on Sep. 15, 2003, now abandoned.
Application No. 10/661,584 is a continuation of application No. 10/167,593, filed on Jun. 13, 2002, now abandoned.
Application No. 10/167,593 is a continuation of application No. 09/546,239, filed on Apr. 10, 2000, now abandoned.
Application No. 09/546,239 is a continuation of application No. 09/175,563, filed on Oct. 20, 1998, now abandoned.

(30) Foreign Application Priority Data
Oct. 20, 1997 (JP) 09-287397
Oct. 20, 1997 (JP) 09/287398

(51) Int. Cl. B23K 9/09

(52) U.S. Cl. 219/130.51

(57) ABSTRACT

The invention provides a welding system capable of freely controlling the dispersion and concentration of arc heat over the groove face with an extreamly narrow gap and a high strength and high quality welded joint structure which is formed by this welding system and which is capable of preventing softening/hardening of the structure, the lowering of the toughness thereof and the generation of a crack. According to the welding system, the melting rate of a welding wire is controlled relative to the welding wire feeding rate by changing the characteristic of an arc current so that the range of behavior and the transfer rate of the arc pole (the arc generating main point at a groove surface) are controlled. Further, the welded joint structure consists of a high strength steel having a superfine grain structure with a carbon equivalent of as low as less than 0.38 and a crystal grain size of less than 7 μm and is welded by a consumable electrode type arc welding method so as to control the arc heat distribution on the groove face of the joint.

### BACKGROUND OF THE INVENTION

1. Field of the Invention

The present invention relates to a welding method and a welded joint structure. More particularly, the invention relates to such type of novel welding method that is capable of welding even an extremely narrow I-gap groove of less than 10 mm, which has hitherto been unable to be welded due to the instability of an arc, and that is capable of freely controlling the arc heat density with respect to the groove face of the base metal and also relates to such type of novel welded joint structure that is capable of providing even a high strength and high quality welded joint which prevents of softening or hardening, the lowering of its toughness and the generation of a weld crack, by using the above-described welding method.

2. Description of the Related Art

Conventionally, in the case of welding mechanical parts and structural materials, from the points of view of prevention of weld deformation and reduction of the amount of heat input at the time of welding, there have been known a gas metal arc welding method (GMA), a submerged arc welding method (SAW), an electro-gas arc welding method (EGW), a shielded metal arc welding method (MMAW) and a self-shield arc welding method (FCA) and there is also known a narrow gap welding method (NGW) for use in welding a joint having a groove gap of about 10 through 12 mm by the GMA method making use of the above-described methods.

Especially, the GMA welding method, using CO₂, Ar—He, Ar—O₂ or Ar—CO₂ shielding gas and SAW welding method are considered to be typical of them.

In the cane of a narrow gap welding method by means of a consumable electrode type arc welding operation is performed such that as shown in FIG. 7, for example, an AC or DC welding power source (1) is connected to a welding wire (3) fed from a welding torch (2) and work (a narrow groove joint) (4) so that a welding arc (5) is generated between them, and works are welded by a weld metal (6).

However, such conventional consumable electrode arc welding method has had the problem that where the groove gap is less than 10 mm, the work can not be welded and consequently, the problem has been unavoidable that the security of the arc heat within the welded joint groove can not be assured resulting in reducing the welding efficiency.

Further, in the conventional methods, due to the fact that the deterioration of the metallurgical property and the deformation by fusion at the welded joint resulting from the concentration of the arc heat are liable to take place, the dispersion of this arc heat at the groove face has become a problem to be controlled.

Consequently, in the case of the consumable electrode type arc welding method, it has become an object to develop a welding method which can secure without fail the arc heat within the welded joint groove, perform a welding operation efficiently in a stabilized manner and freely control the concentration or dispersion of the arc heat.

In the above situation, methods of securing arc heat by mechanically oscillating an arc have come to be employed. For example, in a method which is known as a BBX system, an arc is continuously given the habit of becoming bent in a wavy fashion in the direction of the width of the groove to thereby oscillate the arc. Further, in a TWIST-ARC system, the arc is rotated by a couple of twisted wires and in a bent welding wire system, the arc is oscillated by bending the welding wire with a welding wire bending and shaping gear.

However, in the case of such conventional mechanical oscillating systems, it becomes necessary to provide a separate arc oscillating device in gap width direction.

There has also been proposed a method quite different from the mechanical oscillation system. In the case of the narrow gap welding method disclosed in the Unexamined Published Japanese Patent Application No S47-16357, there is a proposal that when a gas shield consumable electrode arc welding (a narrow groove MIG) method is performed by inserting a welding torch into the welding groove gap between two abutting base metals and a straight polarity welding current with a welding wire as a negative polarity is periodically dropped to a low welding current so that the creeping up of the arc is prevented and the welding operation is performed with a stabilized high DC straight polarity electric current. This proposal is made in consideration of the conventional general problem that there is sometimes a case in which when the welding current is made large, the pole of the arc moves from the tip of the welding wire along the surface of the welding wire to thereby reach the top end of a power supply metal fitting of the welding torch such as a contact tip so that the arc heat within the groove of the welded joint can not be secured without fail and even the top end of the welding torch is also fused.

However, since this method lacks its theoretical background, the welding is forced to depend on the feeling or experience of the operator and actually, it has not been able to control the arc heat with respect to its concentration or dispersion.

In fact, there has been a problem with this method that when the narrow groove gap is made to be less than 10 mm, an arc generates on the surfaces of the base metal resulting in a failure of fusing the inside of the groove.

Further, even with this method, weldabilty of the structure-preserving type method which does not impair the characteristics of the base metal is not satisfactory and the problems of the shape-deformation and the residual stress due to welding have remained unsolved.

As described above in detail, the conventional welding methods have many problems to be solved and moreover, the welded joint structures obtained by using these welding methods also still involve a lot of problems.

More concretely, where, for example, it is intended to improve the strength of a structure by welding high-strength steel materials, there has hitherto been a serious problem that an outstanding hardened zone (300 Hv or more) generates at the welded joint portion which results in the generation of a weld crack.

In order to solve such problem, it is considered to highly strengthen a structure by welding a steel (super-ferrous material) highly strengthened to have a low carbon equivalent superfine grain structure. Such consideration is based on the knowledge that the carbon equivalent of the general steel material is larger than 0.38 but the material cracks when it is subjected to arc welding (with a hydrogen type welding rod) and further that the crystal grain size of its structure is about 20 μm exceeding 7 μm but when fined to a size less than 7 μm, the strength of the structure will improve to a great degree.

However, as a matter of fact, in strengthening a low carbon equivalent superfine grain structure, when the conventional large heat input arc welding operation is performed, the heat-affected zone expands and the fine grain size become coarse so that the generation of a softened zone and the lowering of the toughness of the joint take place resulting in a failure of obtaining a welded joint performance. In short, the above-described high strength steel welded joint structure has not at all been realized up to the present time. Therefore, it becomes indispensable to minimize the base metal fused zone and the heat-affected zone resulting from a small heat input arc welding operation.

On the other hand, up to the present time, such measure has not yet been materialized and it is the actual situation that a high strength and high quality joint structure has not yet been obtained by arc welding high strength steel materials.

Accordingly, the present invention has been made to eliminate the disadvantages of the conventional technology relating to the above-described welding methods and the welded joint structures.

### SUMMARY OF THE INVENTION

An object of the present invention is to provide a novel consumable electrode type arc welding method which requires no mechanical arc oscillation and which is capable of performing an efficient welding operation in a stabilized manner by freely controlling the dispersion and concentration of the arc heat with respect to the groove face of a base metal even when the groove gap is as narrow as less than 10 mm.

Another object of the present invention is to provide a high strength and high quality welded joint structure which is free of softening and hardening and which is capable of preventing the lowering of toughness and the cracking of the joint structure.

### BRIEF DESCRIPTION OF THE DRAWINGS

FIG. 1 is a schematic diagram showing a relationship between the position of a welding wire end and a welding current at the time of DC arc welding;

FIG. 2 is a schematic diagram showing a relationship between the position of a welding wire end and a welding current at the time of AC arc welding;

FIG. 3 is a relation diagram showing a change in the behavior of the end of the welding wire due to a change in the welding current waveform;

FIG. 4 is a relation diagram showing another behavioral change of the welding wire end with respect to a change in the welding current waveform;

FIG. 5 is a relation diagram showing a relationship between the frequency of a fluctuating electrical current and the vertical oscillation amplitude of the welding wire end;

FIG. 6 is a sectional view of a welded joint obtained according to one of the preferred embodiments of the present invention; and

FIG. 7 is a schematic diagram of narrow gap GMA welding.

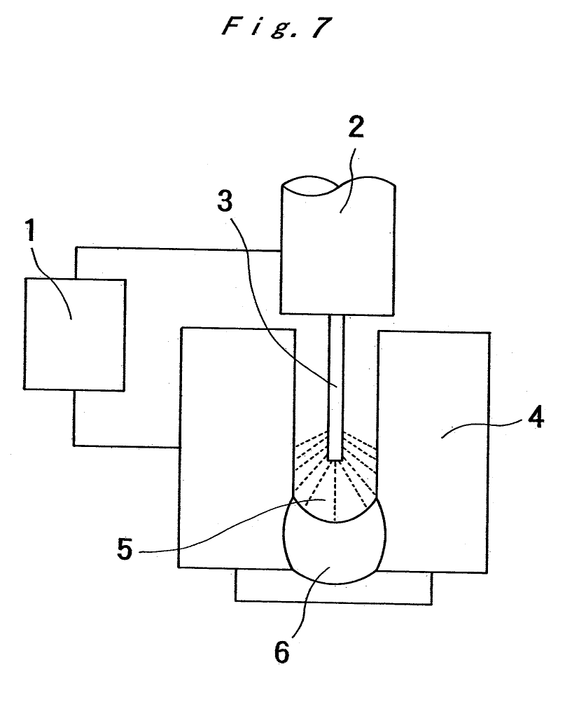

### DETAILED DESCRIPTION OF THE INVENTION

The present invention provides, as means for solving the above-described problem, a welding method of a first aspect of the present invention which is characterized in that the welding wire melting rate is increased or decreased relative to the welding wire feeding rate depending on the change of the arc current characteristics to thereby oscillate to the thickness direction of a base metal the arc generating position at the fusing end of the welding wire, and has made it possible to control the arc heat distribution on the groove face of the base metal.

Furthermore, the invention also provides a welded joint structure of a second aspect of the invention which is welded according to the welding method of the invention and which consists of a high strength steel having a superfine grain structure with a low carbon equivalent of leas than 0.38 and whose crystal grain size is less than 7 μm.

That is, the welding method of the invention has been completed based on the knowledge obtained through a detailed investigation by the present inventors that to enable a stabilized efficient welding operation and a structure deterioration prevented welding operation to be performed, it is indispensable to obtain an optimal arc heat distribution on the groove face of a base metal and for this purpose, it is important to control the melting rate of the welding wire for the range of behavior of the arc foot (the arc current flowing point) on the groove face, that is, with respect to the relationship between the arc current flowing zone on the groove face and the transfer rate of the welding wire. More concretely, the method has been completed on the knowledge that with respect to the position of the fusing end of the welding wire relating to the arc pole on the groove face, the amplitude of the vertical oscillation of the end of the fusing wire welding wire basically depends on the frequency of the fluctuating current waveform and the ratio between the maximum and the minimum currents of the current waveform and further, the transfer rate of the welding wire end strongly depends on the variation of current (current waveform gradient) with respect to time.

That is, the important feature of the method of the invention resides in that in order to obtain the optimum arc heat distribution at the groove face of the base metal, the melting rate of the welding wire is increased or decreased relative to the welding wire feeding rate by changing the arc current characteristics as described above so that unlike the conventional method, the range of behavior of the arc pole, that is, the arc current feeding zone and the transfer rate thereof are controlled without mechanically oscillating the arc.

This fact is also based on a novel idea by the present inventors who have made free use of the theory of heat conduction from the point of view of controlling the width of the heat-affected zone (HAZ) in arc welding. More concretely, the position (rf: fusing width) where the maximum arrival temperature of a moving linear heat source (r=0) in its quasi-stationary state becomes a fusion point (Tf) and the position (rm: the distance from the heat source up to the boundary of the HAZ base metal) where the above-mentioned maximum arrival temperature becomes Ac1 (Tm) are obtained to take a ratio of rm/rf and if, in this case, the welding rate is somewhat high, that ratio will become a constant to be determined only by the value of the physical property of the material.

For example, the value of the ratio of rm/rf of a steel material becomes about 2. This means that the HAZ width (rm-rf) becomes nearly equal to the fused width (rf) and shows that when the fused width is made as small as possible, the HAZ width becomes small accordingly. That is, it is effective to use the present method in which a joint with a narrow gap is welded in such a manner that the distribution of arc heat is dispersed over the groove wall to thereby minimize the heat density thereat and the base metal is slightly fused.

From this point of view, the idea has been derived that the welding wire fusing end (the arc generating main point) is caused to enter into the groove by increasing and decreasing the welding wire melting rate relative to a constant welding wire feeding rate and therewith, the wire fusing end is caused to oscillate in the thickness direction of the base plate.

Furthermore, in the case of the welded joint structure obtained by using the welding method of the present invention having the above-described features, the I-groove gap of the weld zone of a steel material highly strengthened by the formation of a low carbon equivalent superfine grain structure is extremely narrowed and the arc heat is dispersed over a wide range of the groove face so that while it is welded by a high efficiency large current arc welding operation, it is possible to make small the arc heat density distribution at the groove face to a suitable degree. Consequently, the melting zone and heat-affected zone of the base metal can be minimized and these zones can be rapidly heated and cooled thereby preventing to increase grain size the fine grain structure of the base metal. Thus, by these effects, it is possible to prevent the formation of a softened zone and the lowering of toughness in the heat-affected zone.

When a high strength steel material with a low carbon equivalent superfine grain structure is welded by the high current conventional arc welding method, the heat-affected zone of the base metal expands due to arc heat input and the cooling time becomes long in the thermal cycle. Therefore, in the beat-affected zone of the low carbon equivalent fine grain steel (super ferrous material), the fine grain size becomes coarse resulting in the formation of a softened zone or the lowering of toughness of the structure thereby failing to strengthen the resultant welded joint.

Further, where a commercial high-strength steel material is weld by an extremely narrow gap consumable electrode type arc welding method, since the cooling rate is rapid, a hardened zone generates in the welded joint so that a weld crack occurs. On the other hand, in the case of the present invention, the extremely narrow gap consumable electrode type arc welding method is applied to the low carbon equivalent superfine grain structure high strength steel. As the result that a high-quality welded joint without cracks is obtained due to low carbon equivalent.

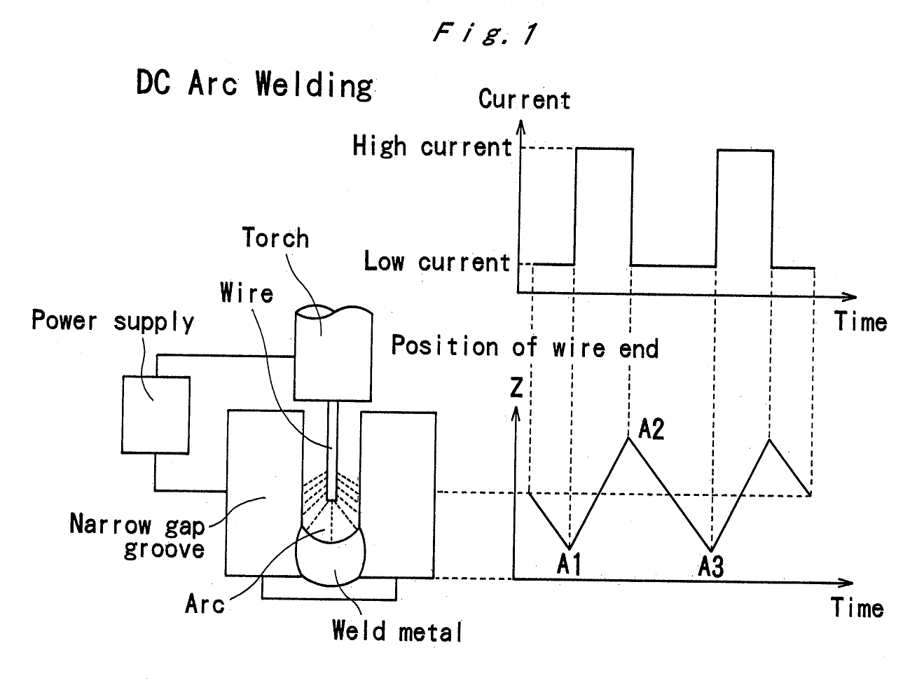

Next, the basic principle of that invention will be described along with FIG. 1. In the case of the DC arc welding, if it is assumed that the welding wire feeding rate is constant as illustrated in FIG. 1. When a high current flows through the welding wire, the fusing end of the welding wire moves upward from a point A1 to a point A2, according to rapid melting of the weld wire.

Then, when the arc current is reduced, the fusing amount of the welding wire becomes small allowing the welding wire end to move downword from the point A2 to the point A3.

The point A2 can be determined to take an optimal value according to the throat depth of a pass in a weld. For example, when a base metal in a thickness of 20 mm is weld by a two-pass welding operations, the point A2 may be set to 10 through 15 mm. When the arc current drops after the arrival of the welding wire end at the point A2, the fusing amount of the welding wire becomes small and the welding wire end moves downword to the point A3. To prevent the lack of fusion at the root of groove, the welding wire end is held at the point A3 and the arc heat is concentrated there for few time. Thus, by moving the welding wire end in the order of A1-A2-A3, the dispersion of the arc heat can be made possible and at same time the concentration of the arc heat at the point A3 can be made possible. At this time, by moving the arc pole in the order of A1-A2-A3, the fusing zone on the inner wall of the groove also moves in the order of A1-A2-A3 so that the dispersion of the arc heat on the inner wall surface of the groove is made possible. Likewise, the welding of a plate material in a thickness of 70 mm can be made possible.

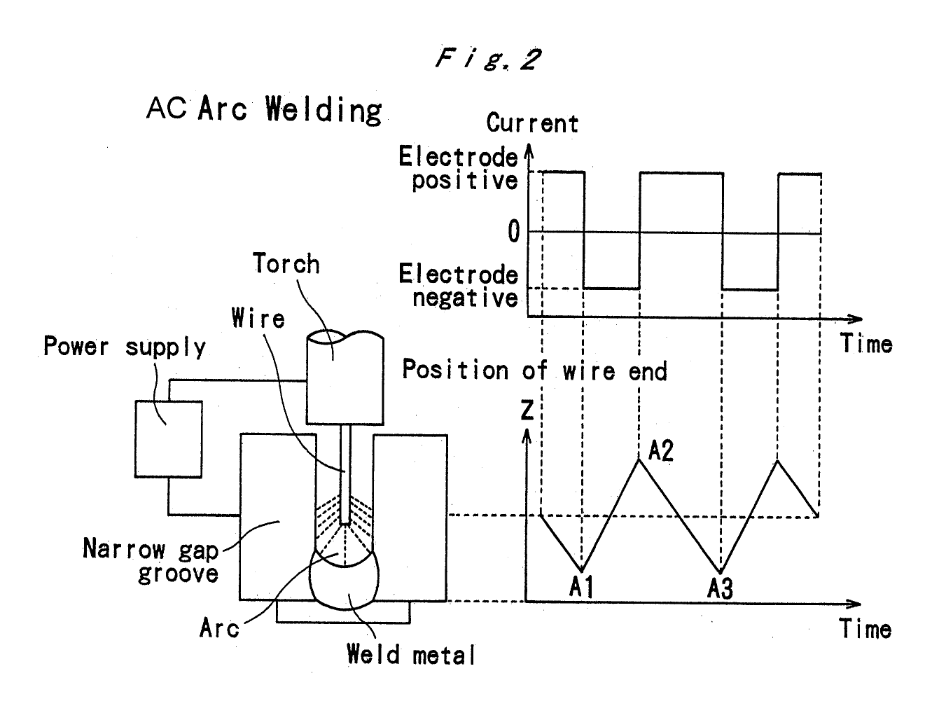

In the case of the AC arc welding. In the case of the AC arc welding, the wire melting rate is large during electrode positive interval, and the wire melting rate is small during electrode negative interval. When the welding wire is a positive electrode with which the welding wire fusing amount is small, the welding wire end is at the point A1 as shown in FIG. 2, while when the welding wire is a negative electrode with which the welding wise fusing amount is large, the welding wire end moves up to the point A2. When the positive electrode wire is again used after using the negative electrode wire, the end of the welding wire moves down to the point A3. Thus, as in the case of the AC arc welding, by moving the welding wire end in the order of A1-A2-A3, the dispersion of the arc heat by the arc pole can be made possible.

With the above arrangement, even the welding of a material having a narrow groove gap of less than 10 mm can be made possible and further, a high-efficiency welding operation in a smaller number of layers than in the case of the conventional method can be realized. At the same time, the arc heat density can be reduced to a great degree. Further, by so controlling the current waveform as to increase the degree of concentration of the arc heat at the point A3, a stable Uranami welding operation becomes possible. In addition, according to the method of the present invention, it is also possible to control the shape of the toe of weld by concentrating the arc heat on the surface of the joint while keeping the welding wire end at the point A2 by properly selecting a current waveform in both of DC and AC arc welding operations. Further, when a narrow gap joint is welded, there sometimes arises a pear-shaped crack at the center of the bead and when there is the possibility of generation of such a crack, it is also possible to increase the amount of heat input at the point A2.

In the case of the welding method of the invention, various kinds of systems of consumable electrode type arc welding are employed among which MIG welding and MAG welding making use of a shield gas of Ar—He, Ar—O₂, Ar—CO₂, and CO₂ may be cited as suitable ones.

Further, where a flux-cored welding wire is used, the prevention of the generation of a welding defect by improving the wettability of the base metal groove wall and the fused metal, the achievement of a high-precision arc heat density distribution by improving the controllability of the arc pole behavior and the expansion of the oscillation range of the welding wire at the time of AC arc welding by improving the welding wire melting rate at the time when the welding wire is a negative electrode are made possible depending on the flux component used whereby the stability and controllability of the welding method of the invention are more improved.

Still further, according to the invention, the arc heat density can be reduced to a great degree to thereby control the formation of any thermal deformation. Since any weld deformation is controlled, the lowering of residual stress relating thereto can be made possible.

In addition, the invention is also effective with respect to a narrow I-groove with a groove gas below 10 mm and the ordinary grooves (K-groove and V-groove) with a small groove angle. Particularly, the effect of the invention is very great for welding an extremely narrow groove having a groove width of less than 6 mm.

As regards base metals targeted by the present invention, no specific limitation is imposed to the kinds of them. They may be general steel, stainless steel, aluminum, heat-resistant steel and corrosion-resistant steel and the like. As regards welding wires, commercial welding wires may be used. Further, as regards the GMA gas conditions, the MIG gas and MAG gas which are generally used may be employed.

Thus, the invention is applicable to a low carbon equivalent welded joint with a carbon equivalent of 0.38 or less.

### DETAILED DESCRIPTION OF THE PREFERRED EMBODIMENTS

The present invention will now be described in detail with reference to the preferred embodiments thereof.

### EMBODIMENT 1

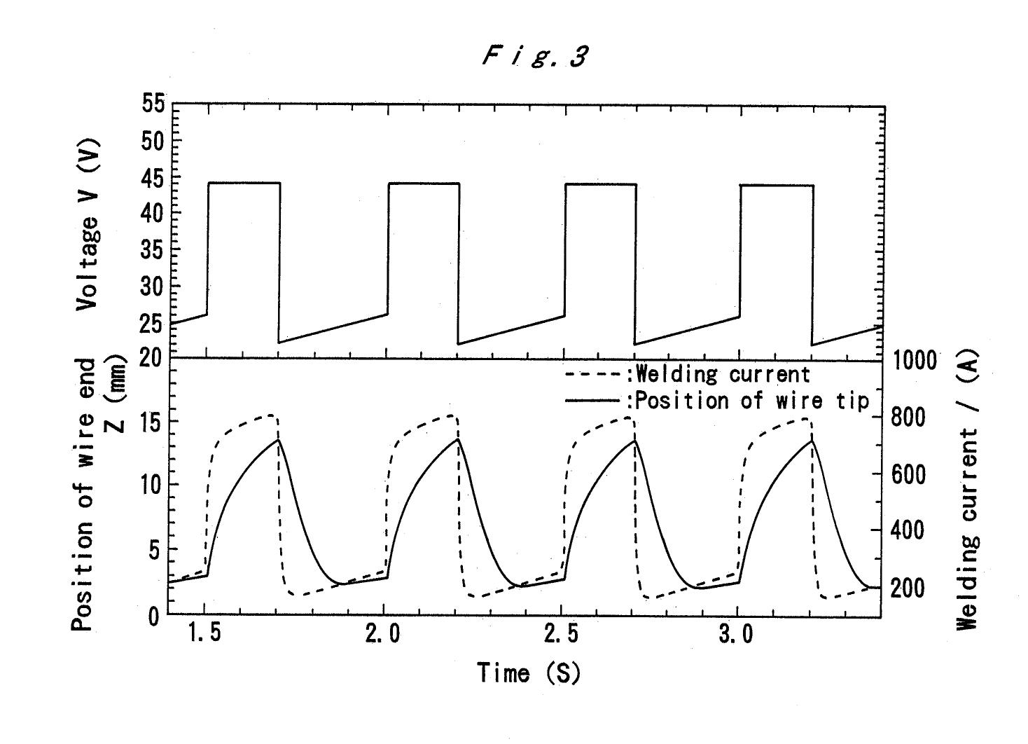

The current waveform was actually changed to measure how the welding wire end behaved. FIG. 3 shows results of welding when the voltage at the time of a high current welding operation was 44V for a period of 0.2 second and when the voltage at the time of a low current welding operation was from 22 V to 25V for a period of 0.3 second. The lower dotted line designates the welding current at the time of the welding and the solid line designates the position of the tip of the welding wire from the back surface of a base metal.

Changing the voltage in the manner as shown in FIG. 3 increases the arc heat at the bottom of the groove to thereby secure melting and is applied to Uranami welding.

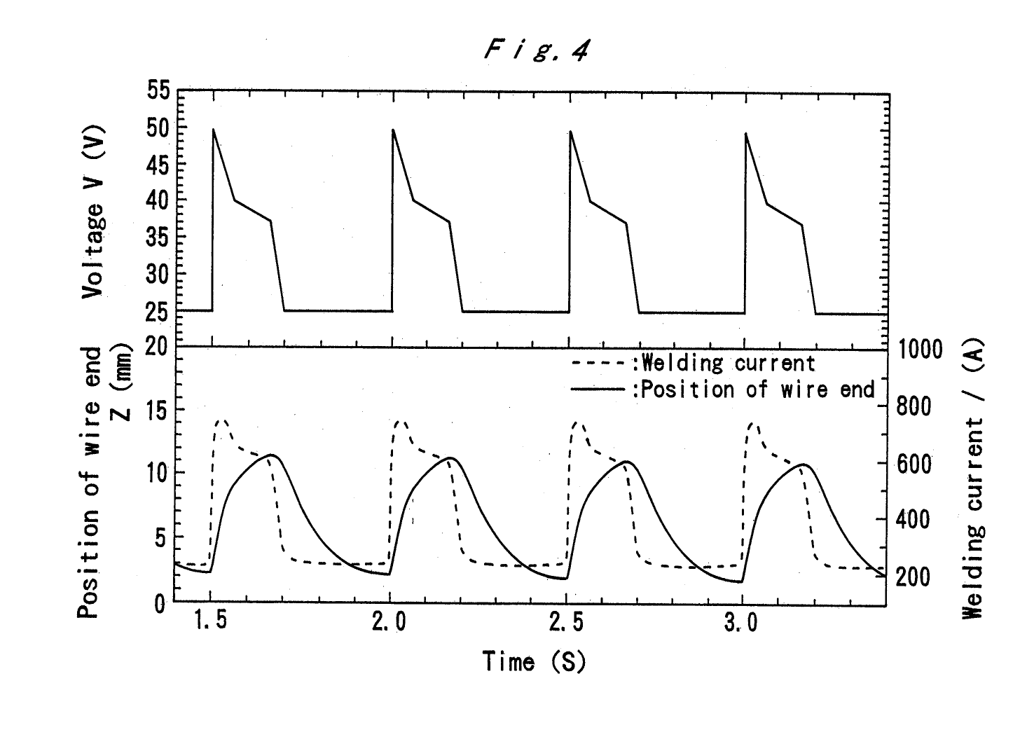

On the other hand, FIG. 4 shows results of welding when the voltage at the time of a high current welding operation was changed in a saw-tooth manner from 50V for a period of 0.2 second and when the voltage at the time of a low current welding operation was 25V for a period of 0.3 second. The lower dotted line designates the welding current at the time of the welding while the solid line designates the position of the tip of the welding wire.

Changing the voltage in the manner as shown in FIG. 4 increases the arc heat on the upper end of wire oscillation to thereby secure melting and is applied to a case where the shape of the bead at the toe of weld is made smooth.

### EMBODIMENT 2

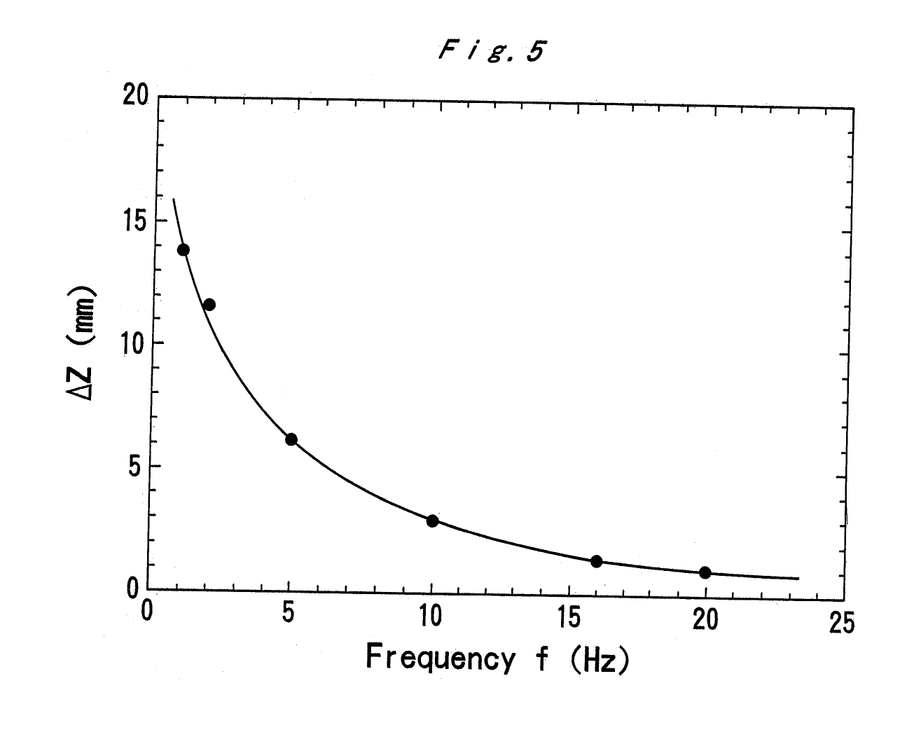

The voltage conditions shown in FIG. 3 according to the embodiment 1, that is, the voltage at the time of the high current welding operation was set to 44V while the voltage at the time of the low current welding operation was set to 25V from 22V and the frequency of the fluctuating current was changed to examine its relationship with the vertical oscillation amplitude, ΔZ of the welding wire end with the result shown in FIG. 5. From this figure, it will be understood that when the frequency of the fluctuating current is made high, the vertical oscillation amplitude, ΔZ of the welding wire end becomes small.

### EMBODIMENT3

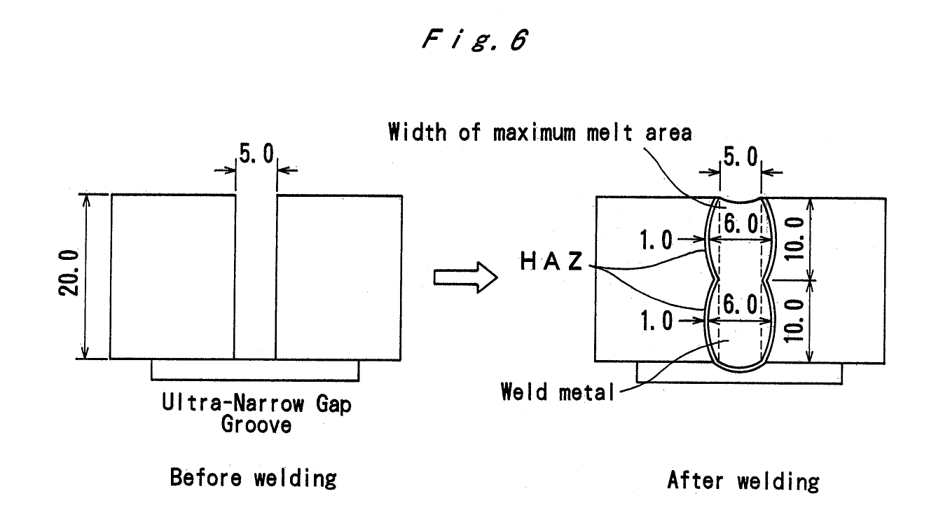

An I-type narrow groove with a sheet thickness of 20 mm and a groove gap of 5 mm was subjected to a DC arc MAG welding operation on conditions that a high current of 600 A was applied for a period of 0.06 second and a small current of 250 A was applied for a period of 0.3 second with the average arc current of 300 A with the result shown in FIG. 6. As shown in the figure, the high-efficiency two layer welding was made possible with each layer having a throat thickness of 10 mm, a welded joint width of 6 mm and the width of the heat-affected zone, that is, the distance of 1 mm from the bonded zone to the heat-affected zone-base metal boundary.

### EFFECT OF THE INVENTION

It is possible with the invention to provide a welding system which is capable of freely controlling the dispersion and concentration of the arc heat on the groove face of the base metal.

Further, according to the invention, since the heat density distribution within the groove can be freely controlled, when the structure preserving type welding which does not impair the characteristics of the base metal at the time of small input heat density distribution, the welding of an extremely narrow groove of a gap of less than 10 mm which has conventionally been unable to perform and Uranami welding of a V-type groove cab be performed. Further, since the melting zone and the heat-affected zone generating at the time of welding can be minimized, it is possible to prevent the generation of a weld deformation and to reduce the residual stress and the concentration of stress due to the control of the shape of the toe of weld.

Still further, it is possible with the invention to form a narrow heat-affected zone and to prevent the generation of a weld crack and a softening/hardening zone by combining the low carbon equivalent superfine grain structure high-strength steel welding method and the extremely narrow gap consumable electrode type arc welding method, to thereby obtain a high-strength, high-toughness and high-quality welded joint performance. Consequently, it is possible to increase the strength, and to extend the life, of the welded structure.

1. A welding method capable of controlling an arc heat distribution on a groove face of a base metal, which comprises increasing or decreasing the melting rate of a welding wire relative to the feeding rate of the welding wire by changing the characteristic of an arc current to thereby change an arc generating position of a fusing end of the welding wire, wherein an AC arc welding operation is performed by changing the polarity of the welding wire as the characteristic of the arc current.

2-4. (canceled)

5. The welding method as claimed in claim 1, wherein a groove welding operation is performed.

6. The welding method as claimed in claim 1, wherein a Uranami welding operation is performed.

7. A welded joint structure formed by claim 1, wherein the welded joint structure consists of a high strength steel having a superfine grain structure with a carbon equivalent of as low as less than 0.38 and a crystal grain size of less than 7 μm.

8. The welded joint structure as claimed in claim 7, wherein the welded joint structure has an extremely narrow groove of less than 10 mm.

9. The welded joint structure as claimed in claim 7, wherein the welded joint structure includes heat affected zone whose hardness is controlled to less than 250 Hv.

10. The welded joint structure as claimed in claim 7, wherein the welded joint structure is welded in a multiplicity of layers.

11. A welded joint structure formed by claim 5, wherein the welded joint structure consists of a high strength steel having a superfine grain structure with a carbon equivalent of as low as less than 0.38 and a crystal grain size of less than 7 μm.

12. A welded joint structure formed by claim 6, wherein the welded joint structure consists of a high strength steel having a superfine grain structure with a carbon equivalent of as low as less than 0.38 and a crystal grain size of less than 7 μm.

13. The welded joint structure as claimed in claim 8, wherein the welded joint structure includes heat affected zone whose hardness is controlled to less than 250 Hv.

14. The welded joint structure as claimed in claim 8, wherein the welded joint structure is welded in a multiplicity of layers.

15. The welded joint structure as claimed in claim 9, wherein the welded joint structure is welded in a multiplicity of layers.
